(19) United States
(12) Patent Application Publication
(10) Pub. No.: US 2017/0239028 A1
(43) Pub. Date: Aug. 24, 2017

(54) TOOTHBRUSH CAPABLE OF SIMULTANEOUSLY BRUSHING ENTIRE SURFACE OF TEETH

(71) Applicant: Kyoung Il BAEK, Hwaseong-si (KR)

(72) Inventor: Kyoung Il BAEK, Hwaseong-si (KR)

(21) Appl. No.: 15/480,372

(22) Filed: Apr. 6, 2017

Related U.S. Application Data
(63) Continuation of application No. PCT/KR2015/010548, filed on Oct. 6, 2015.

(30) Foreign Application Priority Data
Oct. 6, 2014 (KR) 10-2014-0134427
Oct. 5, 2015 (KR) 10-2015-0139445

(51) Int. Cl. A61C 17/34; A46B 9/04; A61C 17/22; A46B 5/00

(52) U.S. Cl. CPC A61C 17/349; A46B 5/0012; A46B 5/0045; A46B 9/045; A61C 17/222; A61C 17/225; A61C 17/224; A61C 17/3481; A61C 17/221

(57) ABSTRACT

The present invention relates to a toothbrush and, more particularly, to a toothbrush produced by providing soft bristles on a side of a solid bar and capable of easily and simultaneously cleaning a total of six surfaces, e.g., upper and lower flat surfaces, upper left and upper right side surfaces, and lower left and lower right side surfaces, of teeth based on a simple user operation of grasping the toothbrush with a hand.

### CROSS-REFERENCES TO RELATED APPLICATIONS

This Application claims the benefit of priority and is a Continuation application of the prior International Patent Application No. PCT/KR2015/010548, with an international filing date of Oct. 6, 2015, which designated the United States, and is related to the Korean Patent Application No. 10-2014-0134427, filed Oct. 6, 2014 and Korean Patent Application No. 10-2015-0139445, filed Oct. 5, 2015, the entire disclosures of all applications are expressly incorporated by reference in their entirety herein.

### BACKGROUND OF THE INVENTION

1. Field of the Invention

The present invention relates to a toothbrush and, more particularly, to a toothbrush produced by providing soft bristles on a side of a solid bar and capable of easily and simultaneously cleaning a total of six surfaces, e.g., upper and lower flat surfaces, upper left and upper right side surfaces, and lower left and lower right side surfaces, of teeth based on a simple user operation of grasping the toothbrush with a hand.

2. Description of Related Art

A general toothbrush produced by providing bristles in any one direction on an easily-graspable solid bar should brush six surfaces (e.g., upper and lower flat surfaces, upper left and upper right side surfaces, and lower left and lower right side surface) of teeth one by one.

As such, many people spend considerable time brushing their teeth in the morning to get ready for work.

In addition, depending on the position of an arm using the toothbrush, an angle of the toothbrush with respect to the teeth, etc., the six surfaces of the teeth may not be evenly cleaned or some parts of the teeth may be rarely, insufficiently, or incorrectly brushed without being noticed by a user.

### BRIEF SUMMARY OF THE INVENTION

Therefore, the present invention has been made in view of the above problems, and it is one object of the present invention to provide a toothbrush capable of allowing a user to simultaneously clean six surfaces, e.g., upper and lower flat surfaces, upper left and upper right side surfaces, and lower left and lower right side surfaces, of teeth all the time.

It is another object of the present invention to provide a toothbrush capable of allowing a user to rapidly and simultaneously clean six surfaces of teeth all the time even when the user brushes the teeth without paying much attention.

It is yet another object of the present invention to provide a toothbrush capable of allowing a user to correctly, rapidly, and simultaneously clean six surfaces of teeth at correct angles even when the user does not intentionally control the direction and angle of the toothbrush or spend equal time on each the six surfaces of the teeth.

The above and other objects can be accomplished by the present invention described below.

In accordance with one aspect of the present invention, provided is a toothbrush capable of correctly providing toothbrushes corresponding to six preset surfaces to meet each other at almost right angles and to touch teeth without interference between bristles provided on the six surfaces in different directions, based on a simple user operation of grasping the toothbrush with a hand, thereby brushing the teeth.

For example, three toothbrushes, e.g., a middle (upper and lower) toothbrush, a left (upper and lower) toothbrush, and a right (upper and lower) toothbrush, each corresponding to two surfaces of the teeth may be coupled together using a coupling means to simultaneously clean a total of six surfaces, e.g., upper and lower flat surfaces, upper left and right side surfaces, and lower left and right side surfaces, of the teeth.

For example, the toothbrush may include a middle toothbrush for simultaneously cleaning upper and lower flat surfaces of the teeth, a left toothbrush meeting the middle toothbrush at right angles to clean upper and lower side surfaces of the teeth in one of two side directions of the teeth, and a right toothbrush meeting the middle toothbrush at right angles to clean upper and lower side surfaces of the teeth in the other of the two side directions of the teeth. The middle toothbrush and the left and right toothbrushes may be coupled together using a coupling means. Bristles may not be provided on the middle toothbrush in middle toothbrush bristle forbidden zones to prevent interference with the left and right toothbrushes meeting the middle toothbrush at right angles, during operation, and bristles may not be not provided on the left and right toothbrush bristles in left and right toothbrush bristle forbidden zones to prevent interference with the middle toothbrush meeting the left and right toothbrushes at right angles, during operation.

The coupling means may include hinges.

The coupling means may include connectors and hinges.

The left and right toothbrushes may include elastic springs (springs or rubber) for elastically opening or closing the left and right toothbrushes away from or toward the middle toothbrush.

The left and right toothbrushes may include gears for opening or closing the left and right toothbrushes away from or toward the middle toothbrush by equal angles, and preventing the left and right toothbrushes from being open beyond a certain angle.

At least one of the middle toothbrush and the left and right toothbrushes may include a typical vibration device (a device using a typical vibration motor and at least one of a motor, a battery, an electronic circuit, a charger, etc.).

A coupled structure of the middle toothbrush and the left and right toothbrushes may be detachable from a middle toothbrush handle by providing a shaft coupling hole under the middle toothbrush and detaching a middle toothbrush handle shaft from the shaft coupling hole, and the left and right toothbrushes may be detachable from the middle toothbrush handle by providing hinge shafts under the left and right toothbrushes and providing arch-shaped coupling rail grooves at sides of the middle toothbrush handle.

The coupled structure of the middle toothbrush and the left and right toothbrushes may be detachable from a middle toothbrush handle by providing a shaft coupling hole under the middle toothbrush and detaching a middle toothbrush handle shaft from the shaft coupling hole. Lower parts of the left and right toothbrushes may be coupled together by a coupling ring using hinges. If the middle toothbrush handle is detached through a large hole provided in the coupling ring, since the bottom part of the coupling ring forms a planar surface, the detached coupled toothbrush structure may be easily stored in an upright orientation.

The toothbrush may further include a vibration plate at a side of a middle toothbrush neck to transfer vibration of the vibration device to the left and right toothbrushes or the middle toothbrush. Vibration coupling grooves may be formed at sides of the vibration plate and sides of left and right toothbrush necks may be inserted into the vibration coupling grooves during operation to transfer vibration there between.

The coupling means may integrally couple the middle toothbrush and the left and right toothbrushes together using slider pistons and a piston guide.

Handles of all of the middle toothbrush and the left and right toothbrushes may be detachable by providing a coupling hole under the piston guide and detaching a vibration shaft of the middle toothbrush handle from the coupling hole.

Handles of all of the middle toothbrush and the left and right toothbrushes may be detachable by providing coupling shafts (or coupling holes) under the left and right toothbrushes and detaching vibration device coupling holes (or shafts) of the left and right toothbrush handles from the coupling shafts (or the coupling holes).

The toothbrush may further include springs in the slider pistons and the piston guide to provide recovery force to the slider pistons.

The toothbrush may further include connectors (links) connected to the left and right toothbrushes, a slider coupled to the connectors using hinges, and a slider recovery spring, to open or close the left and right toothbrushes away from or toward the middle toothbrush by equal angles.

A switch and a switch button may be included in the middle toothbrush handle.

When a user presses the left and right toothbrushes and thus the slider moves rectilinearly, an inclined side surface of the slider may press the switch button to turn on the switch.

As apparent from the fore-going, the present invention advantageously provides a toothbrush capable of simultaneously cleaning a total of six surfaces, e.g., upper and lower flat surfaces, upper left and upper right side surfaces, and lower left and lower right side surfaces, of teeth. As such, a user may simultaneously clean the six surfaces of the teeth without much effort.

Since the user may simultaneously clean the six surfaces of the teeth, a time required to brush the teeth may be reduced and time may be saved, for example, in the morning when the user is busy to get ready for work.

In addition, since toothbrushes corresponding to six preset surfaces are correctly provided to touch the teeth without interference between bristles provided on the six surfaces in different directions, based on a simple user operation of grasping the toothbrush with a hand, the user may easily and correctly clean the six surfaces of the teeth without paying much attention.

Furthermore, if the user simply grasps a handle of the toothbrush of the present invention with a hand and presses left and right toothbrushes with fingers, rectilinear motion of a slider is caused thereby, an inclined side surface of the slider presses a switch button to turn on a switch, and thus the toothbrush operates as an electric toothbrush.

### BRIEF DESCRIPTION OF THE DRAWINGS

FIG. 1 is a perspective view of a toothbrush capable of simultaneously cleaning a total of six surfaces of teeth 70a and 70b, according to the present invention(a user's hand is indicated by an alternating long and short dashed line).

FIG. 2 is a magnified view of toothbrush heads capable of simultaneously cleaning six surfaces of upper teeth and lower teeth.

FIG. 3 is an exploded perspective view of the toothbrush according to the present invention, which includes a middle toothbrush 11, left and right toothbrushes 21a and 21b, and coupling device hinges 13a and 13b.

FIG. 4A is a partially-cutaway perspective view showing that the left and right toothbrushes 21a and 21b and the middle toothbrush 11 are coupled together using the hinges 13a and 13 band that the toothbrush is in a naturally open state.

FIG. 4B is an operational perspective view showing that the distance between the left and right toothbrushes 21a and 21b of FIG. 4A is reduced by grasping the middle toothbrush handle 1 with a hand and pressing left and right toothbrush handles 2a and 2b with fingers.

FIG. 5A is a partially-cutaway top view showing that the left and right toothbrushes 21a and 21b and the middle toothbrush 11 are coupled together using the hinges 13a and 13b and that the toothbrush is in a naturally open state.

FIG. 5B is an operational partially-cutaway top view showing that the distance between the left and right toothbrushes 21a and 21b of FIG. 5A is reduced by grasping the middle toothbrush handle 1 with a hand and pressing the left and right toothbrush handles 2a and 2b with fingers.

FIG. 5C is an operational partially-cutaway top view showing that the distance between the left and right toothbrushes 21a and 21b of FIG. 5B is further reduced and thus the left and right toothbrushes 21a and 21b contact each other.

FIG. 6A is a magnified view of a portion B of gear devices 22a and 22b of FIG. 5A in a case where the left and right toothbrush handles 2a and 2b are fully open and a space at rear parts of gear jaws 27a and 27b is fully closed.

FIG. 6B is a magnified view of a portion C of the gear devices 22a and 22b of FIG. 5C in a case where the left and right toothbrush handles 2a and 2b are fully closed and the space at the rear parts of the gear jaws 22a and 22b is fully open.

FIG. 7 is a magnified view of middle toothbrush bristles 12 and left and right toothbrush bristles 23a and 23b in a case where the left and right toothbrushes 21a and 21b are pressed toward the middle toothbrush 11.

FIG. 8 is a view for describing left and right toothbrush bristle forbidden zones 100a for protecting the middle toothbrush bristles 12, or 12a and 12b, and middle toothbrush bristle forbidden zones 100b for protecting the left and right toothbrush bristles 23a and 23b, in FIG. 7.

FIG. 9A is a view for describing left and right toothbrush bristle forbidden zones 100c for protecting the middle toothbrush 11 with respect to a centerline of the middle toothbrush 11.

FIG. 9B is a view for describing the left and right toothbrush bristle forbidden zones 100a for protecting the middle toothbrush bristles 12, or 12a and 12b, the middle toothbrush bristle forbidden zones 100b for protecting the left and right toothbrush bristles 23a and 23b, and the left and right toothbrush bristle forbidden zones 100c for protecting the middle toothbrush 11 with respect to a centerline of the left and right toothbrush bristles 23a and 23b.

FIG. 9C is a view for describing the left and right toothbrush bristle forbidden zones 100a and the middle toothbrush bristle forbidden zones 100b with respect to a centerline of the middle toothbrush bristles 12.

FIG. 9D is a perspective view for describing the left and right toothbrush bristle forbidden zones 100a and 100c with respect to the middle toothbrush 11.

FIG. 9E is a perspective view for describing the middle toothbrush bristle forbidden zones 100b with respect to the left and right toothbrushes 21a and 21b.

FIG. 9F is a view for describing that the middle toothbrush 11 and the left and right toothbrushes 21a and 21b are extendable to a plural number and thus the forbidden zones 100a and 100b are also extendable.

FIG. 10 is a perspective view of clearance grooves 120a, 120b, 110a, and 110b provided in the middle toothbrush 11 to prevent interference with the left and right toothbrushes 21a and 21b and the left and right toothbrush bristles 23a and 23b during operation (120a and 120b denote clearance grooves for preventing interference with the left and right toothbrush bristles 23a and 23b, and 110a and 110b denote clearance grooves for preventing interference with the left and right toothbrushes 21a and 21b).

FIG. 11 is a view for describing that the left and right toothbrush bristles 23a and 23b meet the middle toothbrush centerline and the middle toothbrush bristles 12a and 12b at right angles.

FIG. 12 is a view for describing operations of the left and right toothbrushes 21a and 21b and the middle toothbrush 11 on back teeth.

FIG. 13 is a perspective view of a toothbrush capable of simultaneously cleaning a total of six surfaces of the teeth 70a and 70b and further including a typical vibration device 180 according to the present invention.

FIG. 14A is an exploded perspective view of the toothbrush of FIG. 13, which further includes the typical vibration device 180 according to the present invention.

FIG. 14B is a perspective view of the toothbrush further including the typical vibration device 180 according to the present invention, in a case where a coupled structure of the middle toothbrush 11 and the left and right toothbrushes 21a and 21b is detached from a middle toothbrush handle 10a.

FIG. 15A is a perspective view of the toothbrush further including the typical vibration device 180 according to the present invention, in a case where the coupled structure of the middle toothbrush 11 and the left and right toothbrushes 21a and 21b is attached to the middle toothbrush handle 10a.

FIG. 15B is an operational partially-cutaway perspective view showing that the distance between the left and right toothbrushes 21a and 21b of FIG. 15A is reduced by grasping the middle toothbrush handle 10a with a hand and pressing the left and right toothbrush handles 2a and 2b with fingers (the left and right toothbrushes 21a and 21b are cut).

FIG. 15C is an operational partially-cutaway perspective view showing that the distance between the left and right toothbrushes 21a and 21b of FIG. 15B is further reduced and thus the left and right toothbrush bristles 23a and 23b contact each other.

FIG. 16 shows a cross-section A-A′ of a vibration plate 15, a cross-section B-B′ of a middle part of the middle toothbrush handle 10a, and a cross-section C-C′ of left and right toothbrush hinge shafts 24a and 24b, in FIG. 15A.

FIG. 17 is a perspective view of a toothbrush which is capable of simultaneously cleaning a total of six surfaces of the teeth 70a and 70b and further includes the typical vibration device 180 according to the present invention and in which the left and right toothbrushes 21a and 21b are coupled together using a coupling ring 5.

FIG. 18 is a perspective view of the toothbrush according to the present invention in a case where a coupled toothbrush structure (a coupled structure of the middle toothbrush 11 and the left and right toothbrushes 21a and 21b) of FIG. 17 is detached from a middle toothbrush handle 10b.

FIG. 19A is a perspective view showing that the ring 5, or 5a and 5b of FIG. 18 is disassembled from the left and right toothbrushes 21a and 21b.

FIG. 19B is a perspective view showing that the ring 5, or 5a and 5b of FIG. 19A is assembled with the left and right toothbrushes 21a and 21b.

FIG. 20A is a perspective view of a toothbrush which further includes the typical vibration device 180 according to the present invention and in which the left and right toothbrushes 21a and 21b are coupled together using the coupling ring 5 and the coupled toothbrush structure (the coupled structure of the middle toothbrush 11 and the left and right toothbrushes 21a and 21b) is attached to the middle toothbrush handle 10b.

FIG. 20B is an operational perspective view showing that the distance between the left and right toothbrushes 21a and 21b of FIG. 20A is reduced by grasping the middle toothbrush handle 10b with a hand and pressing the left and right toothbrush handles 2a and 2b with fingers.

FIG. 21A is a plan view of a toothbrush according to the present invention, which further includes the typical vibration device 180 and from which the left and right toothbrushes 21a and 21b are detachable.

FIG. 21B is a plan view of a toothbrush according to the present invention, which further includes the typical vibration device 180 and in which lower parts of the detachable left and right toothbrushes 21a and 21b are tied using the ring 5.

FIG. 21C is a plan view showing a modified embodiment of a toothbrush according to the present invention, which further includes the typical vibration device 180, in which the lower parts of the detachable left and right toothbrushes 21a and 21b are tied using the ring 5, and which further includes two-link connectors 41a and 41b and hinges 42a and 42b, the springs 3a and 3b, and the gears 22a and 22b.

FIG. 21D is a plan view showing a modified embodiment of a toothbrush according to the present invention, which further includes the vibration devices 180 at ends of the left and right toothbrushes 21a and 21b.

FIG. 21E is a plan view showing a modified embodiment of a toothbrush according to the present invention, which includes four columns of the left and right toothbrushes 21a and 21b or the bristles 23a and 23b (Alternatively, the number of columns may be reduced or increased to one or a plural number as necessary).

FIG. 21F is a perspective view showing a modified embodiment of a toothbrush according to the present invention, which further includes the connectors 41a and 41b serving as springs 4a and 4b, and the hinges 42a and 42b.

FIG. 21G is a partially-cutaway top view showing a modified embodiment of a toothbrush according to the present invention, which includes an ‘elastic rubber ball’ 31 to serve as a spring, instead of the spring 3, or 3a and 3b.

FIG. 21H is a partially-cutaway top view showing a modified embodiment of a toothbrush according to the present invention, which includes ‘handle-integrated springs’ 32a and 32b to form an elastic spring structure by extending sides of the left and right toothbrushes 21a and 21b and to serve as springs, instead of the spring 3, or 3a and 3b.

FIG. 21I is a perspective view showing a modified embodiment of a toothbrush according to the present invention, in which the middle toothbrush 11 and the left and right toothbrushes 21a and 21b are integrally coupled using sliders and springs, the typical vibration device 180 embedded in the middle toothbrush handle 10b is coupled using a shaft 181, and the left and right toothbrushes 21a and 21b are operable by pressing the toothbrush handles 2a and 2b.

FIG. 21J is an exploded perspective view showing that the middle toothbrush 11 and the left and right toothbrushes 21a and 21b of FIG. 21I are integrally coupled using the sliders and the springs.

FIG. 21K is a perspective view showing a modified embodiment of a toothbrush according to the present invention, in which the middle toothbrush 11 and the left and right toothbrushes 21a and 21b are integrally coupled using the sliders and the springs, typical vibration devices 180 embedded in the left and right toothbrush handles 2a and 2b are coupled to shafts 20a and 20b provided at sides of the left and right toothbrushes 21a and 21b, and the left and right toothbrushes 21a and 21b are operable by pressing the toothbrush handles 2a and 2b.

FIG. 22 is a perspective view showing a modified embodiment of a toothbrush according to the present invention, which further includes a slider 43, or 43a and 43b coupled to the hinges 42a and 42b of the connectors (links) 41a and 41b connected to the left and right toothbrushes 21a and 21b, and a slider recovery spring 3e to open or close the left and right toothbrushes 21a and 21b away from or toward the middle toothbrush 11 by equal angles and to smoothly operate the left and right toothbrushes 21a and 21b.

FIG. 23 is an exploded perspective view showing connections between the slider 43 of FIG. 22 and other internal parts such as a switch 80 and a battery module 9.

FIG. 24 is a perspective view showing that the slider 43 of FIG. 22 is naturally pushed by the spring 3e to maintain an open state of the left and right toothbrushes 21a and 21b.

FIG. 25 is a perspective view showing that the left and right toothbrushes 21a and 21b of FIG. 24 are pressed with a hand, the slider 43 compresses the spring 3e, and thus the left and right toothbrushes 21a and 21b contact the middle toothbrush 11.

FIG. 26 is a partially-cutaway perspective view of the slider 43 and a middle toothbrush handle 10d of FIG. 24.

FIG. 27 is a magnified view of the partially-cutaway part of FIG. 26.

FIG. 28 is a perspective view showing that the battery module 9 of FIG. 22 is detachable or removable.

FIG. 29 is a view showing that the toothbrush of FIG. 22 according to the present invention, into which the battery module 9 is inserted, is docked on an external battery charger 92a, to be charged.

FIG. 30 is a view showing that only the battery module 9 detached from the toothbrush of FIG. 22 according to the present invention is directly docked on an external battery charger 92b, to be charged.

FIGS. 31, 32, and 33 are views for describing the ‘left and right toothbrush bristle forbidden zones 100a for protecting the middle toothbrush bristles 12a and 12b’, the ‘middle toothbrush bristle forbidden zones 100b for protecting the left and right toothbrush bristles 23a and 23b’, and the ‘left and right toothbrush bristle forbidden zones 100c for protecting the middle toothbrush 11’, which vary based on shapes of the left and right toothbrushes 21a and 21b and the middle toothbrush 11, and positions of the middle toothbrush bristles 12a and 12b, and the left and right toothbrush bristles 23a and 23b.

### DETAILED DESCRIPTION OF THE INVENTION

### Mode of the Invention

Hereinafter, the present invention will be described in detail by explaining embodiments of the invention with reference to the attached drawings. The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art.

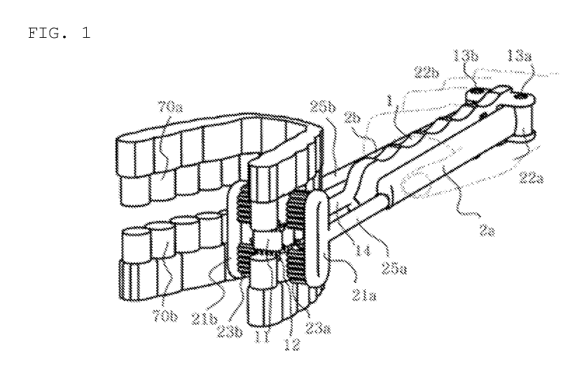

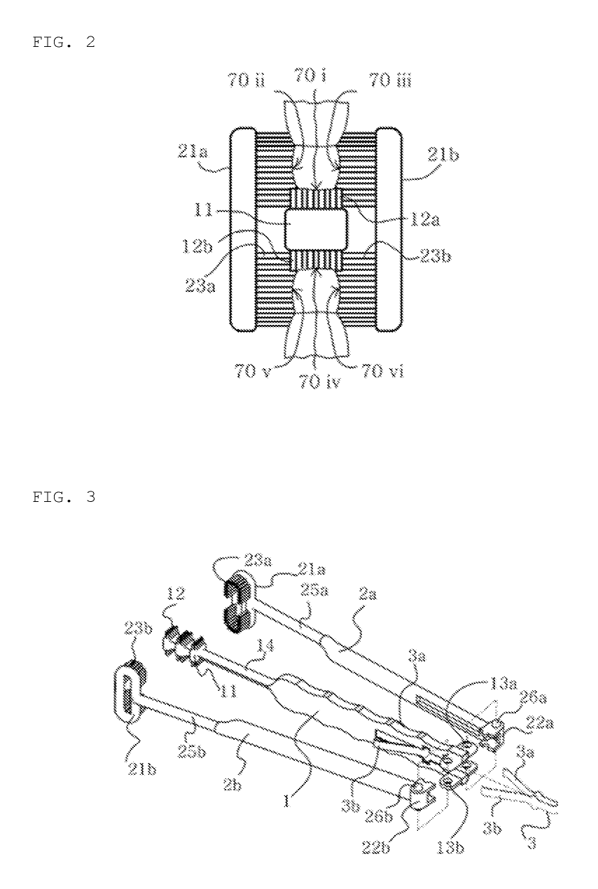

Referring to FIGS. 1 to 12, as illustrated in FIG. 1, in a toothbrush according to the present invention, when a user grasps a middle toothbrush handle 1, 10a, 10b, or 10c of a middle toothbrush 11 and gently presses handles 2a and 2b of left and right toothbrushes 21a and 21b with the thumb and other fingers(the user's hand is indicated by an alternating long and short dashed line), the bristles 23a and 23b of the left and right toothbrushes 21a and 21 b contact upper and lower side surfaces of teeth 70a and 70b. At the same time, when the teeth 70a and 70b are slightly clenched, upper and lower flat surfaces of the teeth 70a and 70b contact middle toothbrush bristles 12, or 12a and 12b and, as illustrated in FIG. 2, six surfaces of the teeth 70a and 70b (e.g., left and right side surfaces 70ii and 70iii of the upper teeth, left and right side surfaces 70v and 70vi of the lower teeth, flat surfaces 70i and 70iv of the upper and lower teeth in FIG. 2) may be simultaneously cleaned.

That is, if the users imply grasps the toothbrush of the present invention with a hand by gently applying pressure and clenches the teeth 70a and 70b, the six surfaces of the teeth 70a and 70b (FIGS. 2: 70ii, 70iii, 70v, 70vi, 70i, and 70iv) may be simultaneously cleaned.

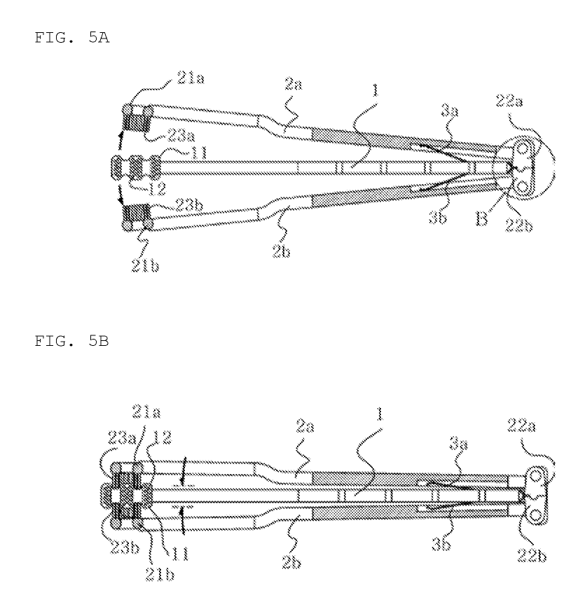

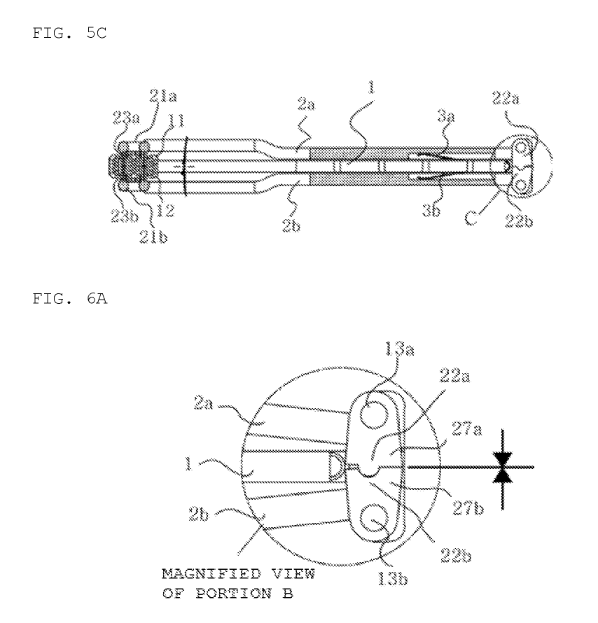

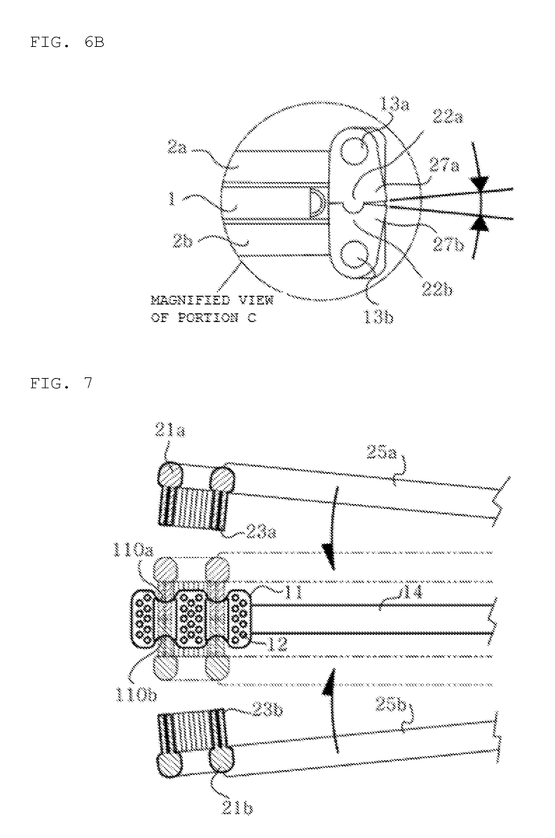

In the above operation, the left and right toothbrushes 21a and 21b connected to two hinges 13a and 13b integrated with the middle toothbrush handle 1 of the middle toothbrush 11 operate only in a certain orbit like a ring 5, or 5a and 5b and meet a centerline of the middle toothbrush 11 and centerlines of the middle toothbrush bristles 12, or 12a and 12b at right angles as illustrated in FIG. 11. In addition, gears 22a and 22b open or close the left and right toothbrushes 21a and 21b away from or toward the middle toothbrush 11 by equal angles as illustrated in FIGS. 5A to 6B, and a space at rear parts of gear jaws 27a and 27b prevents the handles 2a and 2b from being open beyond a certain angle as illustrated in FIGS. 6A and 6B.

Referring to FIG. 2, the toothbrush of FIG. 1 according to the present invention may contact and clean six surfaces of the teeth 70a and 70b. Specifically, the toothbrush contacts a total of six surfaces, e.g., the left side surface 70ii, the right side surface 70iii, and the flat surface 70i of the upper teeth, and the left side surface 70v, the right side surface 70vi, and the flat surface 70iv of the lower teeth.

FIG. 3 is an exploded view showing all parts of the toothbrush of FIG. 1. The middle toothbrush 11 and the left and right toothbrushes 21a and 21b are operable using a combination of a spring 3, or 3a and 3b, the gears 22a and 22b, the hinges 13a and 13b, etc.

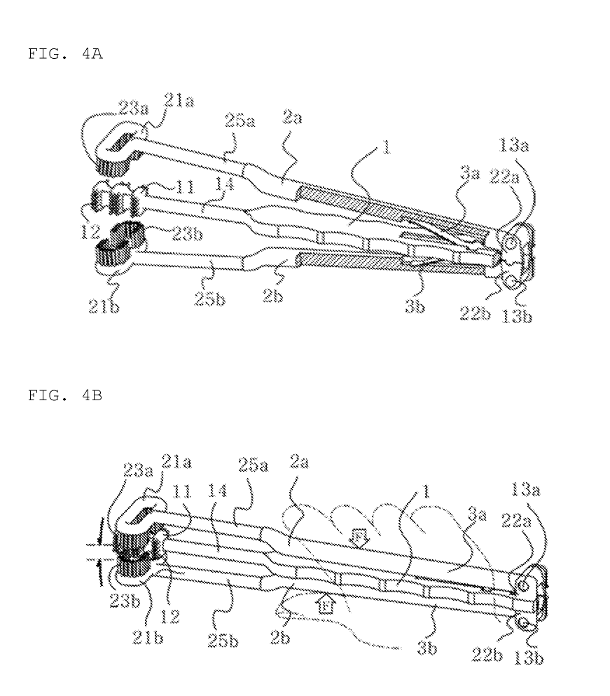

Based on FIGS. 4A, 4B, 5A, 5B, and 5C showing the toothbrush of FIG. 1, which is partially cutaway, operations of the spring 3, or 3a and 3b, the gears 22a and 22b, and the hinges 13a and 13b in a case where the left and right toothbrushes 21a and 21b are open or closed may be understood.

FIGS. 6A and 6B are magnified views of a portion B of the gears 22a and 22b of FIG. 5A in a case where the handles 2a and 2b are open, and a portion C of the gears 22a and 22b of FIG. 5C in a case where the handles 2a and 2b are closed. The gears 22a and 22b move the left and right handles 2a and 2b away from or toward the middle toothbrush 11 by equal angles, and the space at the rear parts of the gear jaws 27a and 27b prevents the left and right handles 2a and 2b from being open beyond a certain angle.

FIG. 7 is a magnified view of heads of the left and right toothbrushes 21a and 21b and the middle toothbrush 11 and shows that the left and right toothbrush bristles 23a and 23b operate without interference with the middle toothbrush bristles 12, or 12a and 12b.

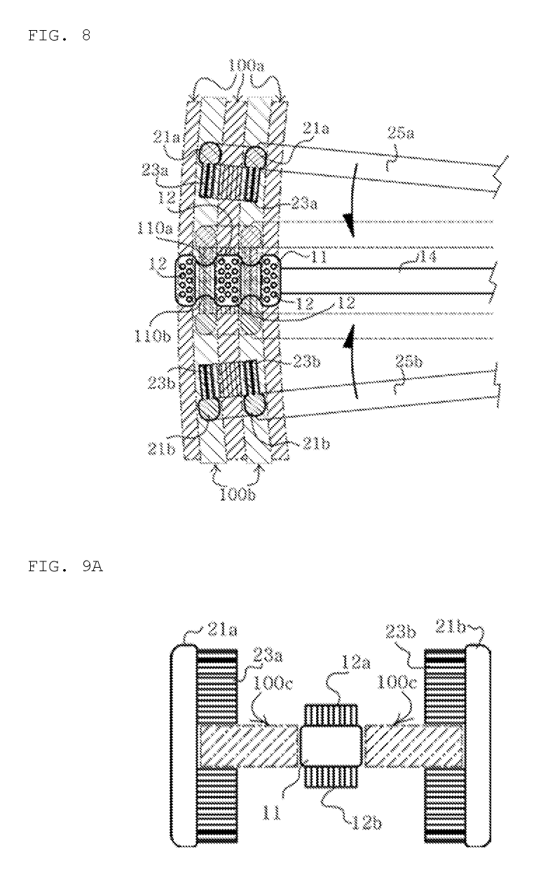

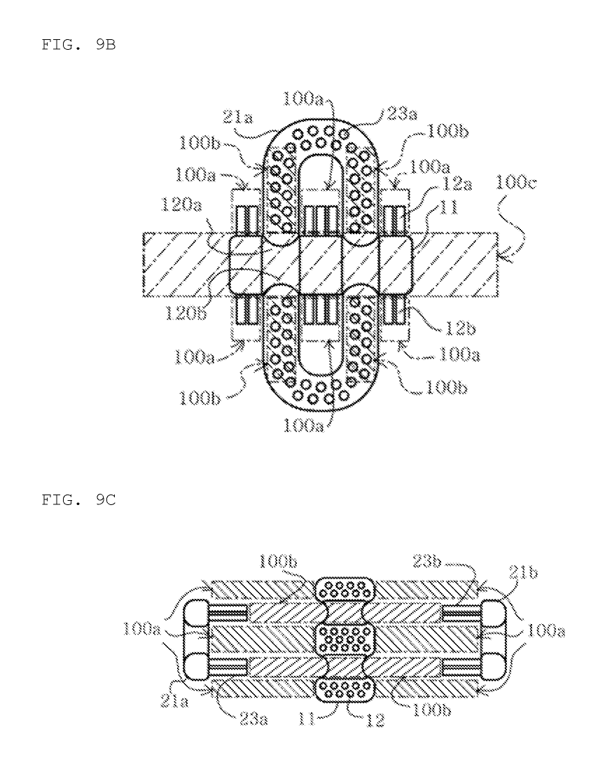

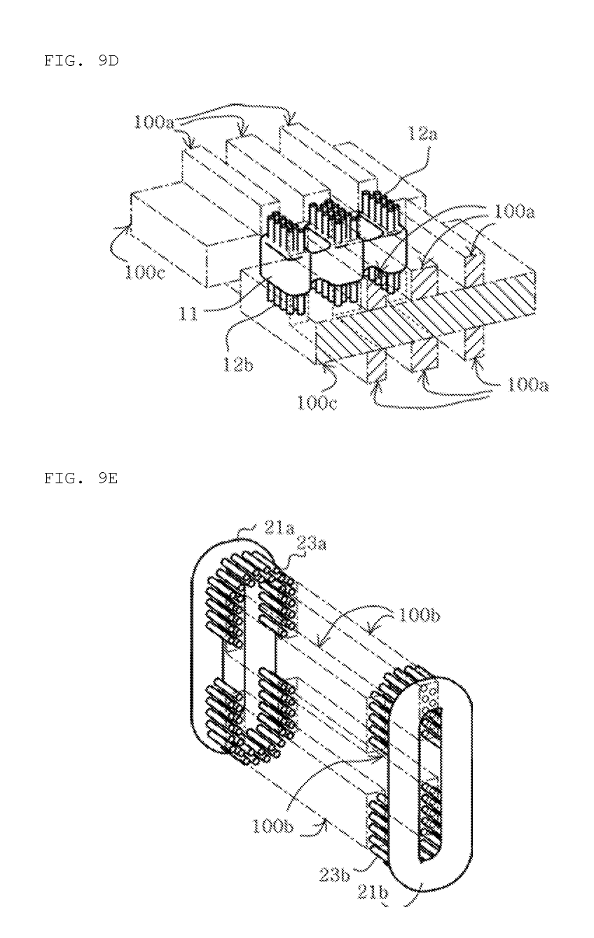

Requirements for operation without interference will now be described with reference to FIGS. 8 and 9A to 9F. To prevent interference between the bristles 12, and 23a and 23b, the toothbrush according to the present invention mainly includes three bristle protection zones, e.g., left and right toothbrush bristle forbidden zones 100a for protecting the middle toothbrush bristles 12, or 12a and 12b, middle toothbrush bristle forbidden zones 100b for protecting the left and right toothbrush bristles 23a and 23b, and left and right toothbrush bristle forbidden zones 100c for protecting the middle toothbrush 11.

Referring to FIG. 8, in general, since the left and right toothbrushes 21a and 21b meet left and right side surfaces of the middle toothbrush 11 at right angles, when the left and right toothbrushes 21a and 21b are pressed toward the middle toothbrush 11, collision inevitably occurs at final positions where the left and right toothbrushes 21a and 21b meet the middle toothbrush 11 at 90°. The interference may be prevented by not providing the bristles 12, and 23a and 23b in certain zones. In the left and right toothbrushes 21a and 21b, interference with the middle toothbrush bristles 12, or 12a and 12b may be prevented by not providing the bristles 23a and 23b in the forbidden zones 100a. In the middle toothbrush 11, interference with the left and right toothbrush bristles 23a and 23b may be avoided by not providing the bristles 12, or 12a and 12b in the forbidden zones 100b where the left and right toothbrush bristles 23a and 23b are operable. When viewed from the centerline of the middle toothbrush 11 as illustrated in FIG. 9A, the bristles 23a and 23b of the left and right toothbrushes 21a and 21b should not be provided in forbidden zones corresponding to the left and right side surfaces of the middle toothbrush 11, thereby preventing collision with the side surfaces. These forbidden zones are the left and right toothbrush bristle forbidden zones 100c for protecting the middle toothbrush 11.

FIG. 9B, 9C, 9D, and 9E shows the forbidden zones 100a, 100b, and 100c in different views.

FIG. 9F shows that the middle toothbrush 11 and the left and right toothbrushes 21a and 21b are extendable or reducible in number.

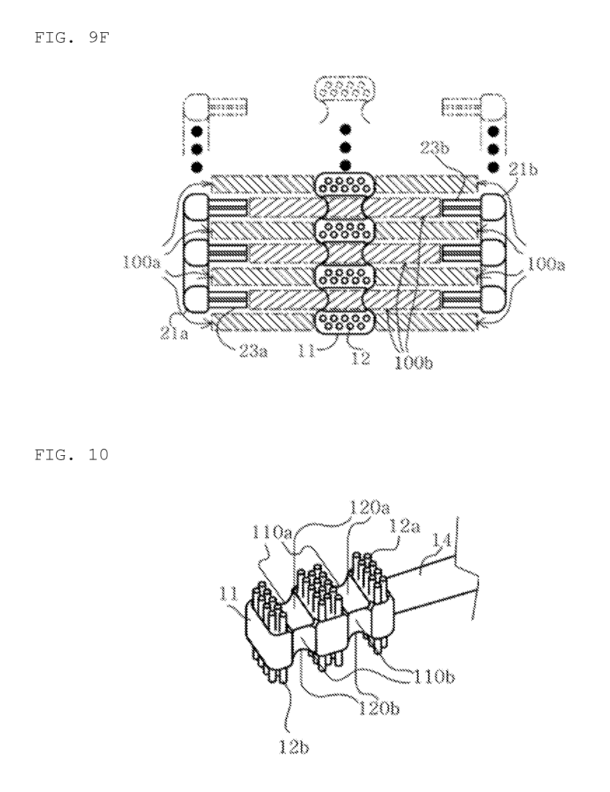

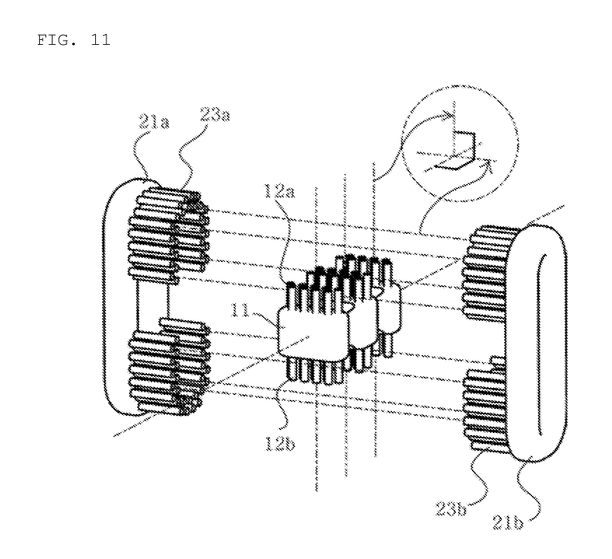

Referring to FIG. 10, in the toothbrush according to the present invention, the middle toothbrush 11 may include clearance grooves 120a, 120b, 110a, and 110b in parts where the left and right toothbrushes 21a and 21b or the bristles 23a and 23b approach, to more effectively reduce interference with the left and right toothbrushes 21a and 21b and the bristles 23a and 23b during operation.

Referring to FIG. 11, the left and right toothbrushes 21a and 21b meet the centerline of the middle toothbrush 11 and the centerlines of the middle toothbrush bristles 12, or 12a and 12b at right angles during operation.

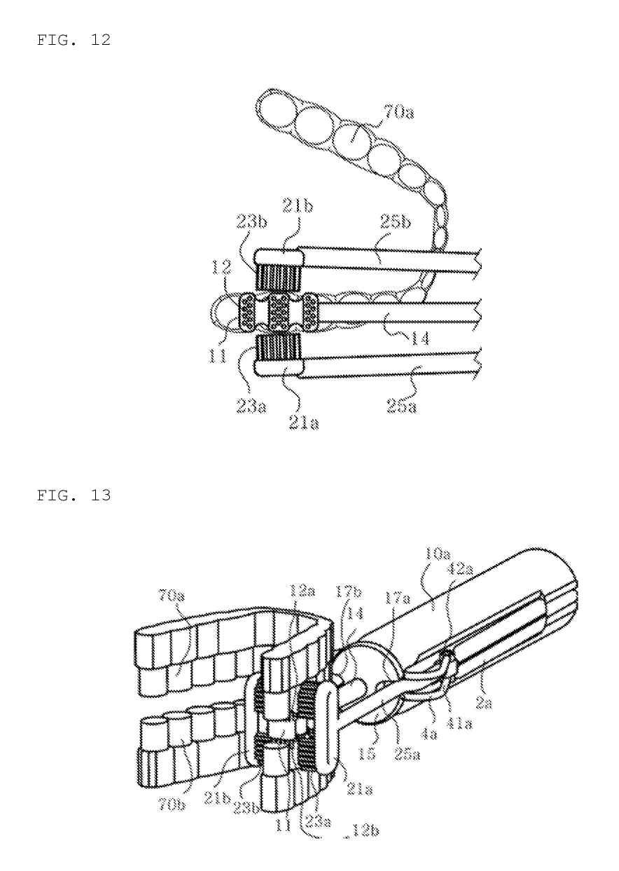

FIG. 12 shows contact between the toothbrush according to the present invention and the teeth 70a and 70b, and shows that the bristles 23a and 23b of the left and right toothbrushes 21a and 21b meet the centerline of the middle toothbrush 11 at right angles.

FIG. 13 shows operation of a toothbrush further including a vibration device 180 according to the present invention, compared to FIG. 1.

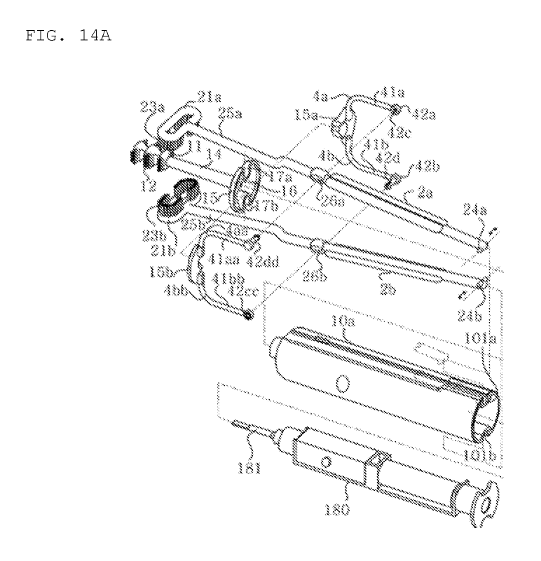

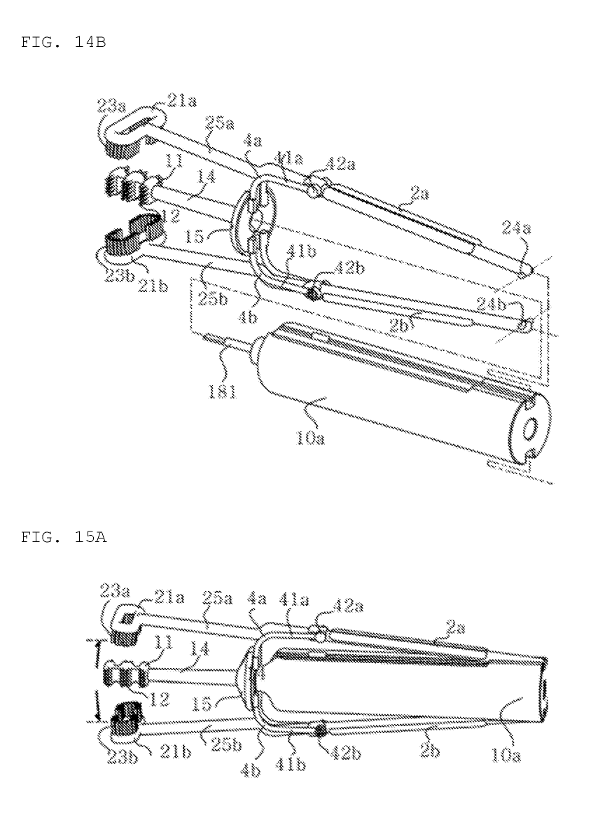

FIG. 14A is an exploded perspective view of the toothbrush of FIG. 13.

FIG. 14B shows a coupled structure of the middle toothbrush 11 and the left and right toothbrushes 21a and 21b, which is detachable from the middle toothbrush handle 10a.

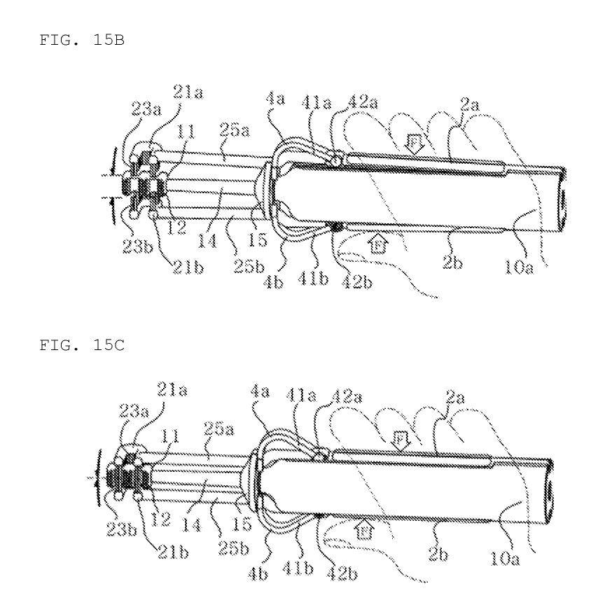

Referring to FIGS. 15A, 15B, and 15C, when no external force is applied, the toothbrush is open due to left and right toothbrush connectors 41a and 41b and elastic springs 4a and 4b as illustrated in FIG. 15A. In this state, if the middle toothbrush handle 10a is grasped with a hand and force is gradually applied, the left and right toothbrush bristles 23a and 23b gradually move toward and contact each other as illustrated in FIGS. 15B and 15C, to clean the teeth 70a and 70b.

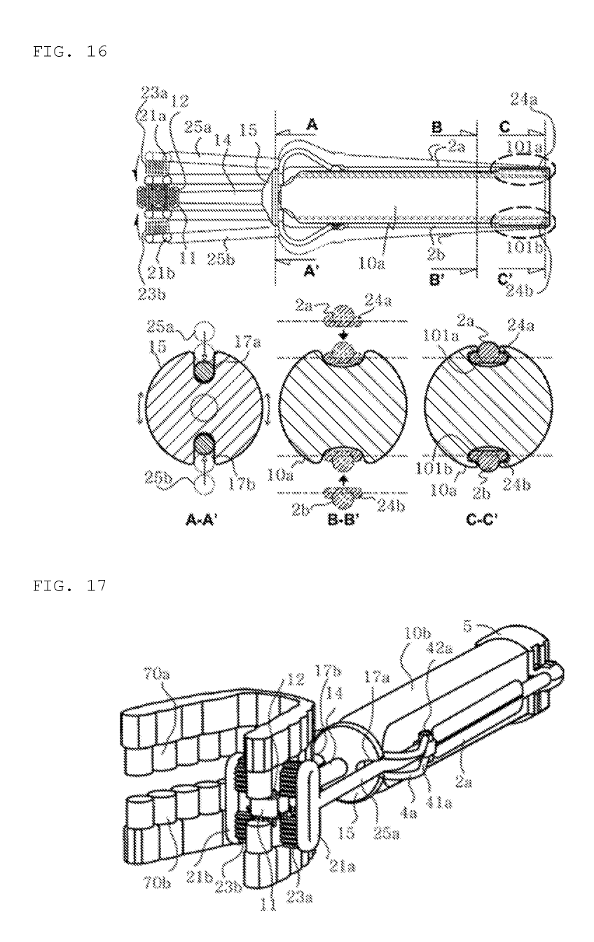

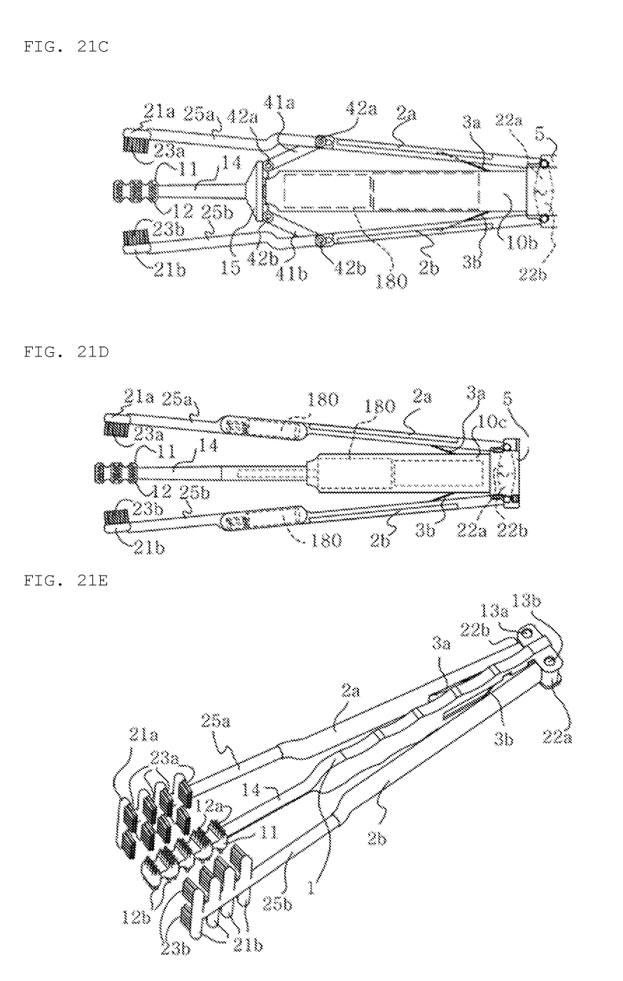

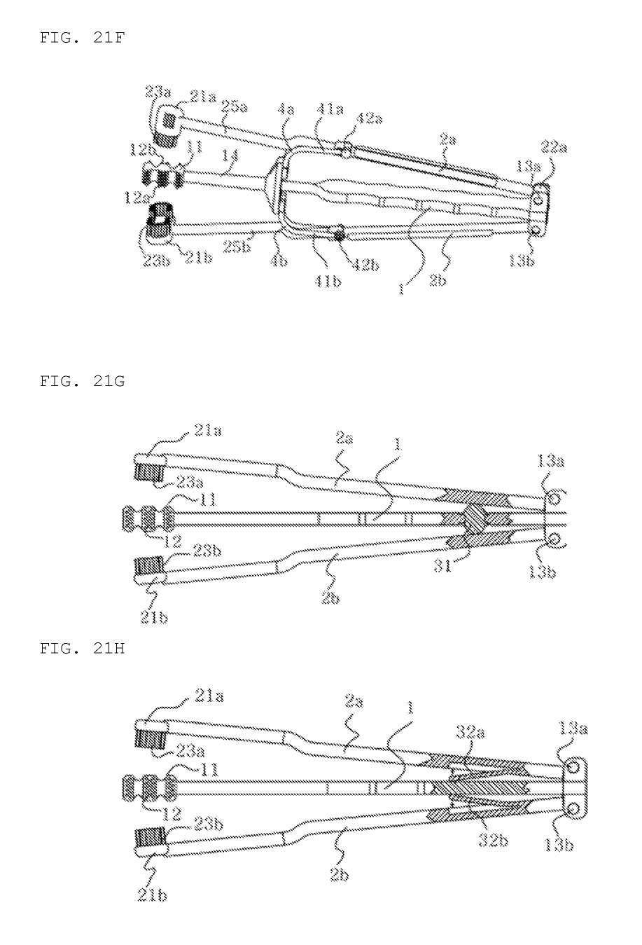

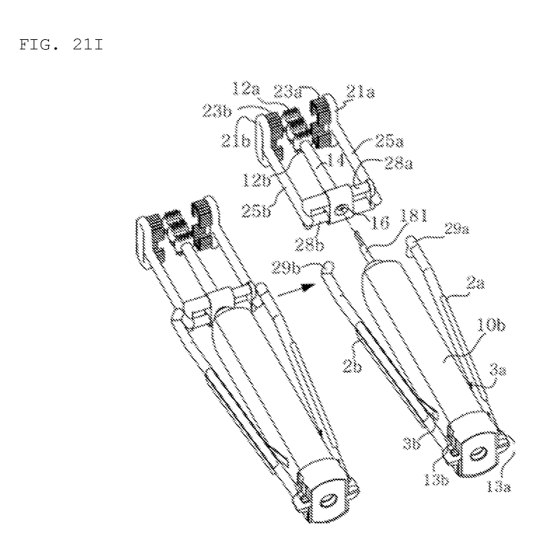

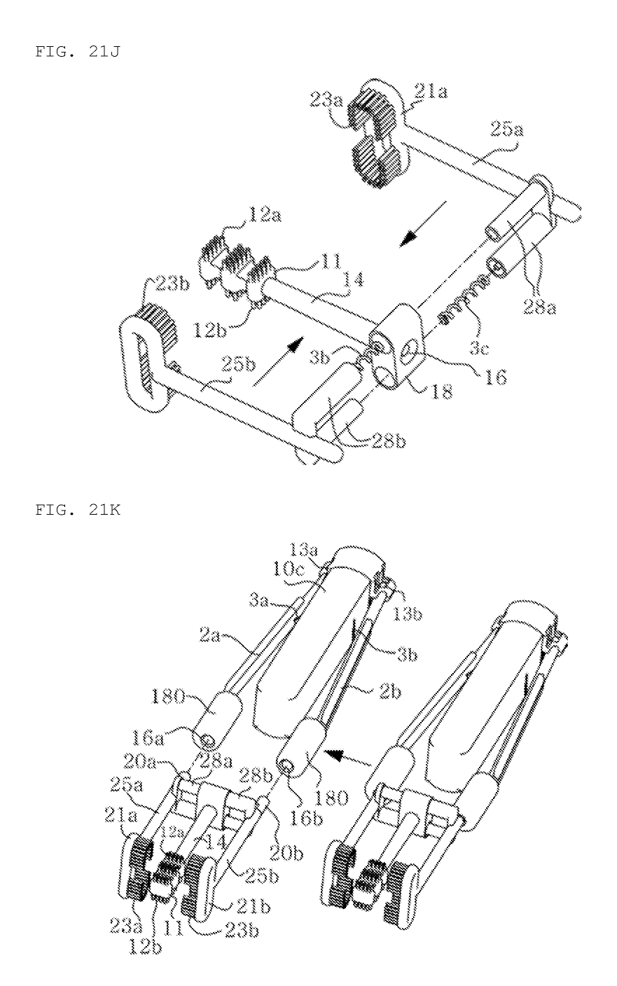

In the above-described toothbrush further including the vibration device 180 according to the present invention, in order to transfer vibration of the vibration device 180 coupled to the middle toothbrush 11, to the left and right toothbrushes 21a and 21b, or in order to transfer vibration of the left and right toothbrushes 21a and 21b to the middle toothbrush 11 in a case where vibration devices 180 are included in the left and right toothbrushes 21a and 21b as illustrated in FIG. 21D, if the left and right toothbrushes 21a and 21b are pressed by a certain angle or more as shown in a cross-section A-A′ of FIG. 16, left and right toothbrush necks 25a and 25b of the left and right toothbrushes 21a and 21b are fitted into vibration coupling grooves 17a and 17b of a middle toothbrush vibration plate 15 and thus vibration of the vibration device 180 is transferred via the middle toothbrush vibration plate 15.

Referring to FIG. 14B, the left and right toothbrushes 21a and 21b and the middle toothbrush 11 are coupled to the left and right toothbrush connectors 41a and 41b using hinges 42a and 42b and are integrally detached. As such, when the user grasps and detaches the middle toothbrush 11 from a middle toothbrush handle shaft 181, hinge shafts 24a and 24b provided under the left and right toothbrushes 21a and 21b are detached along coupling rail grooves 101a and 101b provided in the middle toothbrush handle 10a. Thus, the coupled structure of the middle toothbrush 11 and the left and right toothbrushes 21a and 21b of another user may be attached to the middle toothbrush handle 10a.

Referring to FIG. 17, the toothbrush of FIG. 1 according to the present invention further includes the vibration device 180 provided in the middle toothbrush handle 10b, and the ring 5 for tying lower parts of the left and right toothbrushes 21a and 21b.

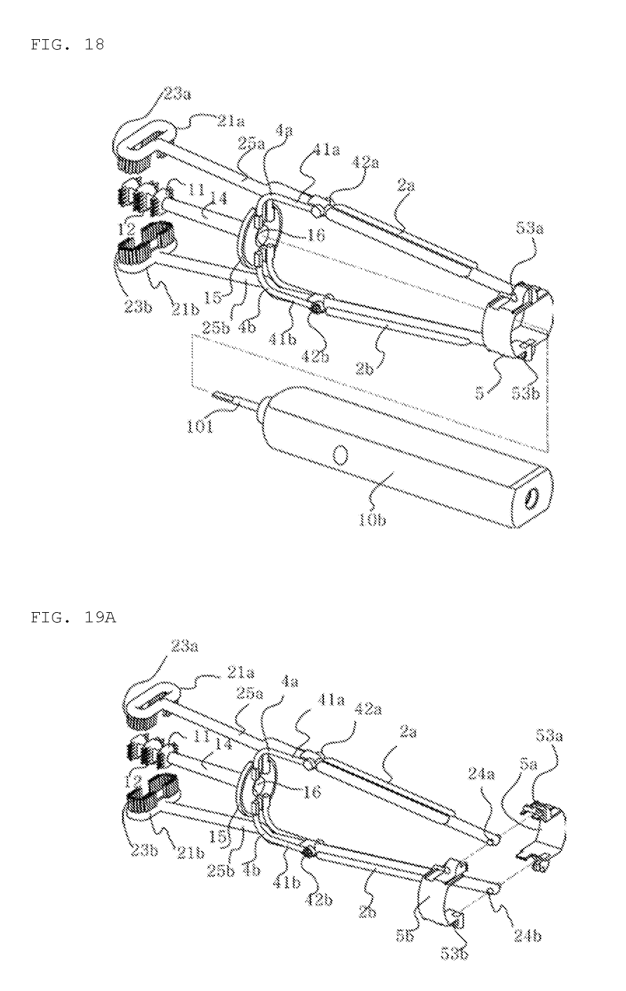

That is, referring to FIG. 18 showing that the coupled structure coupled by the ring 5 is detached from the middle toothbrush handle 10b, since the left and right toothbrushes 21a and 21b are coupled together once again using the ring 5, the user may conveniently detach the coupled structure from the middle toothbrush handle 10a and store the coupled structure in an upright orientation.

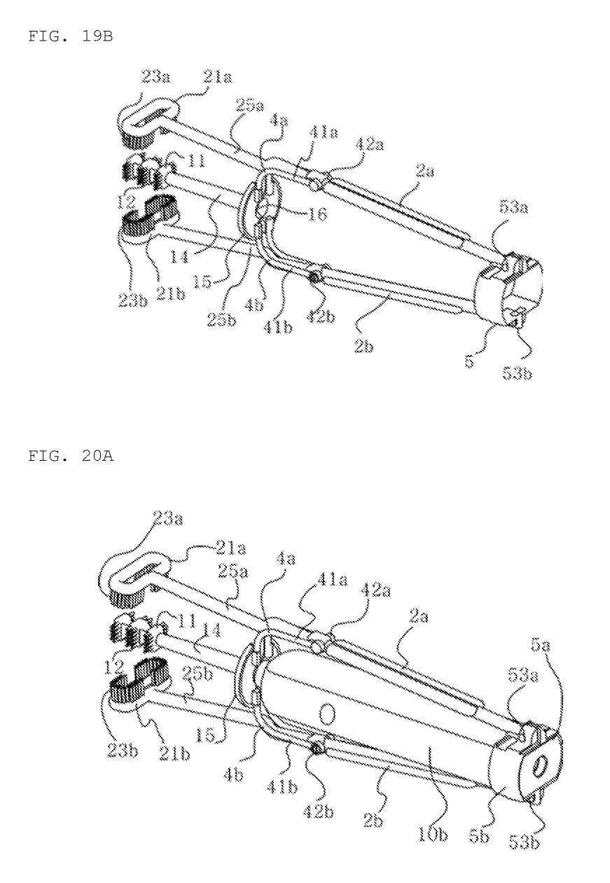

For better understanding of the ring 5, FIG. 19A shows that the ring 5, or 5a and 5b is disassembled from the coupled structure of the middle toothbrush 11 and the left and right toothbrushes 21a and 21b, and FIG. 19B shows that the ring 5 is assembled with the coupled structure.

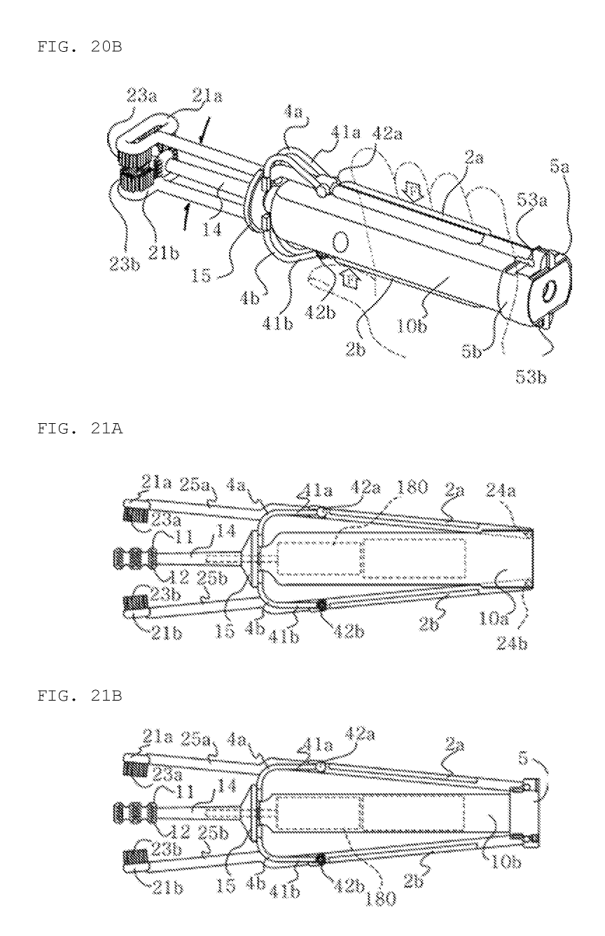

FIG. 20A shows a naturally open state of the toothbrush of FIG. 17 according to the present invention, and FIG. 20B shows that the distance between the left and right toothbrushes 21a and 21b of FIG. 20A is reduced by grasping the middle toothbrush handle 10b with a hand and pressing the left and right toothbrush handles 2a and 2b with fingers.

FIG. 21A is a plan view showing an embodiment of a toothbrush according to the present invention, which further includes the typical vibration device 180 of the present invention and a coupling means for coupling the middle toothbrush 11 and the left and right toothbrushes 21a and 21b together, and from which the coupled toothbrush structure is detachable.

FIG. 21B is a plan view showing an embodiment of a toothbrush according to the present invention, which further includes the typical vibration device 180 of FIG. 18 and in which a lower part of the coupled structure of the middle toothbrush 11 and the left and right toothbrushes 21a and 21b is tied using the ring 5 to easily detach the coupled structure and store the coupled structure in an upright orientation.

FIG. 21C is a plan view showing an embodiment of a toothbrush according to the present invention, which further includes the typical vibration device 180 of FIG. 17 and in which the lower part of the detachable coupled structure of the middle toothbrush 11 and the left and right toothbrushes 21a and 21b is tied using the ring 5, the connectors 41a and 41b are coupled using the two hinges 42a and 42b, the springs 3a and 3b are added, and the left and right toothbrush gears 22a and 22b are installed.

FIG. 21D is a plan view showing an embodiment of a toothbrush according to the present invention, which further includes the vibration devices 180 at sides of the left and right toothbrushes 21a and 21b compared to the previous embodiment of FIG. 21A, 21B, or 21C.

FIG. 21E shows a modified embodiment of a toothbrush according to the present invention, which includes four columns of the left and right toothbrushes 21a and 21b or the middle toothbrush bristles 12a and 12b. Alternatively, the number of columns may be reduced or increased to one or a plural number as necessary.

FIG. 21F shows a modified embodiment of a toothbrush according to the present invention, in which the middle toothbrush 11 and the left and right toothbrushes 21a and 21b are coupled together using the connectors 41a and 41b and the hinges 42a and 42b, and side parts of the connectors 41a and 41b serve as the springs 4a and 4b, instead of the spring 3, or 3a and 3b added to the toothbrush of FIGS. 1 and 3.

FIG. 21G shows a modified embodiment of a toothbrush according to the present invention, which includes an ‘elastic rubber ball’ 31 to serve as a spring, instead of the spring 3, or 3a and 3b.

FIG. 21H shows a modified embodiment of a toothbrush according to the present invention, which includes ‘handle-integrated springs’ 32a and 32b to form an elastic spring structure by extending sides of the left and right toothbrushes 21a and 21b and to serve as springs, instead of the spring 3, or 3a and 3b added to the toothbrush of FIGS. 1 and 3. Alternatively, it may be easily understood that springs integrated with the middle toothbrush handle 1 may also be formed at sides of the middle toothbrush handle 1.

FIG. 21I shows a modified embodiment of a toothbrush according to the present invention, in which the middle toothbrush 11 and the left and right toothbrushes 21a and 21b are integrally coupled using slider pistons 28a and 28b and a slider guide 18, the shaft 181 of the typical vibration device 180 embedded in the middle toothbrush handle 10b is inserted into a coupling hole 16 provided under a middle toothbrush neck 14, for attachment, detachment, and vibration transfer, and the left and right toothbrushes 21a and 21b may approach the teeth by pressing the toothbrush handles 2a and 2b to operate the pistons 28a and 28b.

Referring to FIG. 21J, the middle toothbrush 11 and the left and right toothbrushes 21a and 21b of FIG. 21I are coupled together using the slider pistons 28a and 28b and the slider guide 18, and springs 3b and 3c are further included therein to provide recovery force to the pistons 28a and 28b. The pistons 28a and 28b are inserted into the slider guide 18 and move rectilinearly. Since the pistons 28a and 28b are configured as large and small pistons and the small pistons are inserted into the large pistons, motion stability may be increased. The springs 3b and 3c are included in the pistons 28a and 28b.

FIG. 21K shows a modified embodiment of a toothbrush according to the present invention, in which the middle toothbrush 11 and the left and right toothbrushes 21a and 21b are integrally coupled using the slider pistons 28a and 28b and the slider guide 18, shafts 20a and 20b provided at sides of the left and right toothbrushes 21a and 21b are inserted into shaft coupling holes 16a and 16b and thus coupled to the typical vibration devices 180 embedded in the left and right toothbrush handles 2a and 2b, for attachment, detachment, and vibration transfer, and the left and right toothbrushes 21a and 21b are operable due to shaft-coupling by pressing the toothbrush handles 2a and 2b to operate the pistons 28a and 28b.

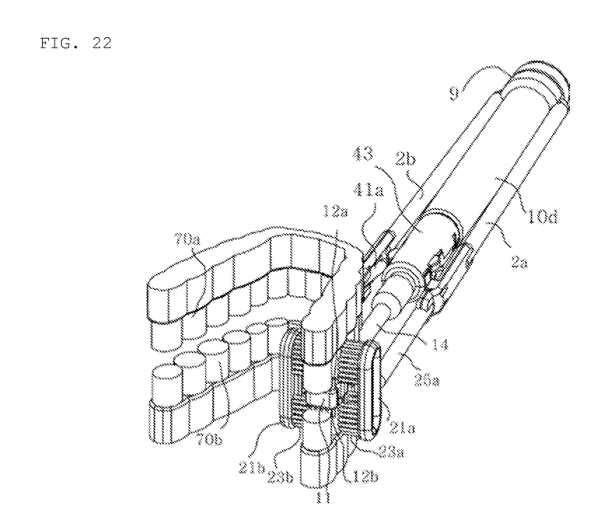

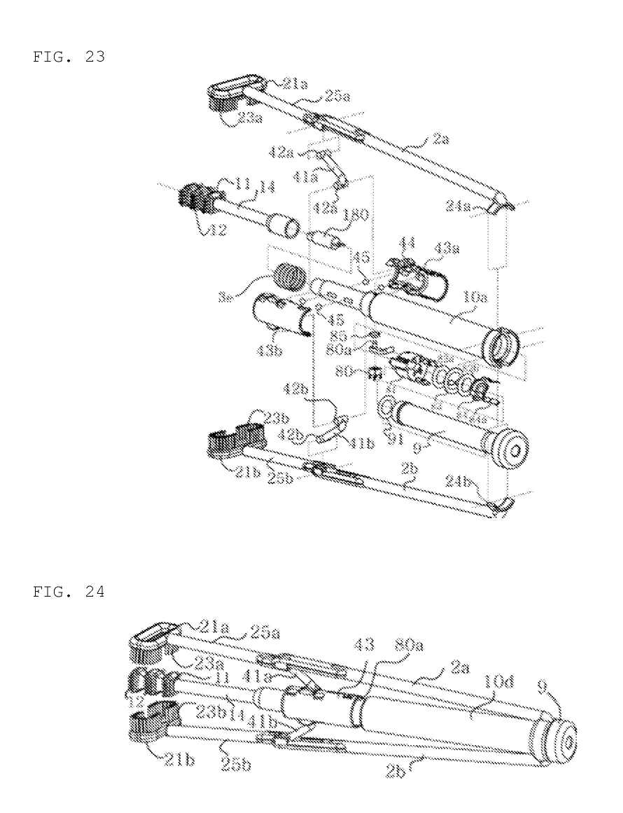

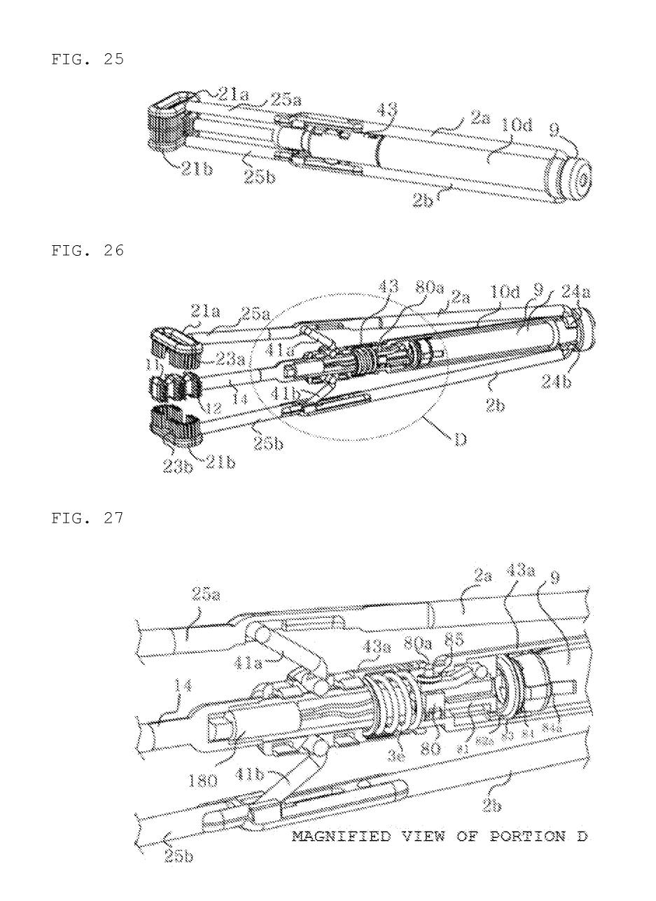

Referring to FIG. 22, the left and right toothbrushes 21a and 21b may be simultaneously open by equal angles due to rectilinear motion of a slider 43 by coupling the slider 43 to the connectors 41a and 41b using the hinges 42a and 42b.

FIG. 23 shows connections between the slider 43 of FIG. 22 and other internal parts such as a switch 80 and a battery module 9. Herein, parts such as the switch 80, a switch frame 81, and the battery module 9 are not required for a manual toothbrush but are essential for an electric toothbrush.

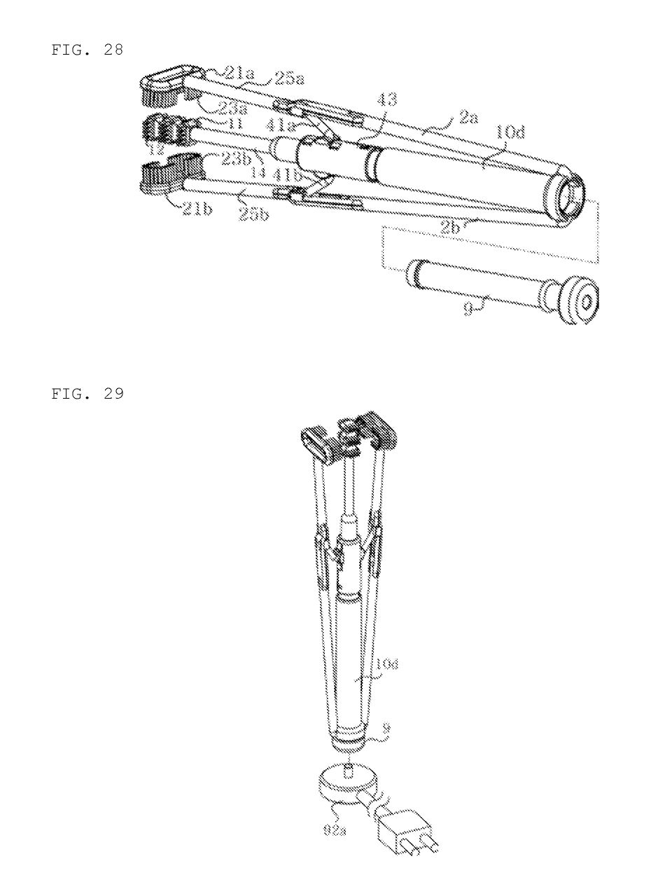

Referring to FIG. 24, the slider 43 is maintained in a naturally open state due to elasticity of a spring 3e included therein.

Referring to FIG. 25, when the user grasps a middle toothbrush handle 10d with a hand and softly presses the left and right toothbrushes 21a and 21b with fingers, the pressure pushes the spring and thus the left and right toothbrushes 21a and 21b contact the middle toothbrush 11.

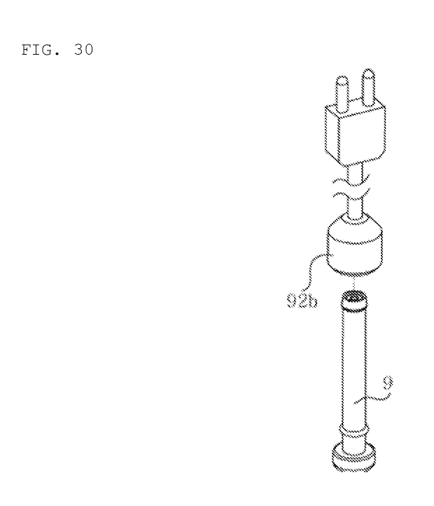

FIG. 26 is a partially-cutaway perspective view of the slider 43, the middle toothbrush handle 10d, and the switch frame 81 of the toothbrush according to the present invention in a naturally open state, and shows connection among the connectors 41a and 41b, the slider 43, and the spring 3e.

FIG. 27 is a magnified view of the cut part of FIG. 26. In this state, if the user presses the left and right toothbrushes 21a and 21b with a hand, the connectors 41a and 41b push the slider 43 rightward, the spring 3e is compressed, an inclined side surface of the slider 43 presses the switch button 80a to turn on the switch 80, the vibration motor 180 vibrates, and the high-frequency vibration is transferred not only to the middle toothbrush 11 but also to the left and right toothbrushes 21a and 21b via the connectors 41a and 41b.

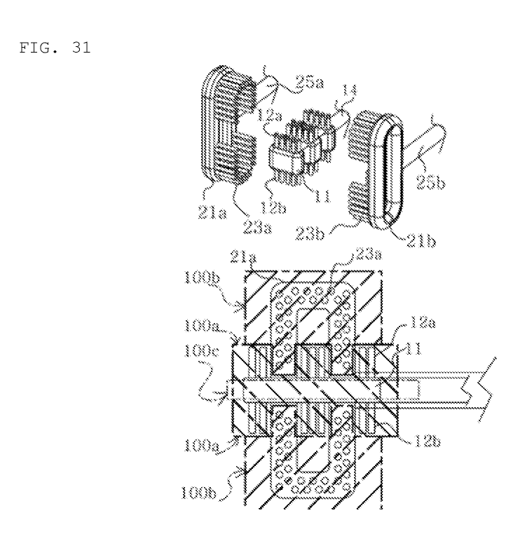

FIG. 28 shows a modified embodiment of a toothbrush according to the present invention, in which the battery module 9 is removable from a toothbrush body to which the left and right toothbrushes 21a and 21b and the middle toothbrush 11 are coupled, to use the toothbrush as a manual toothbrush, and is detachable to use the toothbrush as an electric toothbrush.

FIG. 29 shows an example in which the toothbrush into which the battery module 9 is inserted is docked on a battery charger 92a, to be charged.

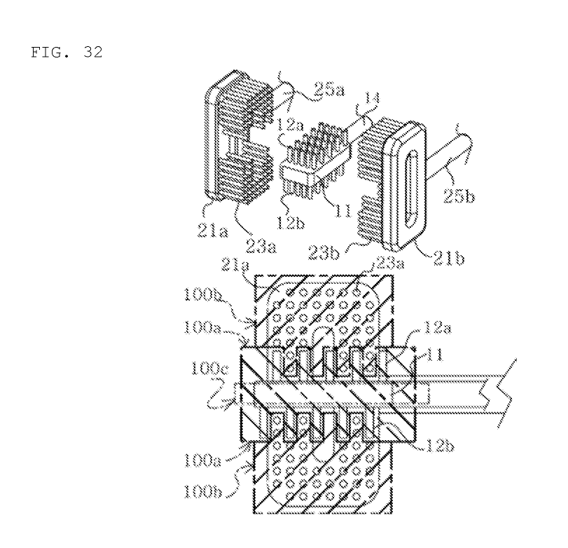

FIG. 30 shows an example in which only the detached battery module 9 is docked on a battery charger 92b, to be charged.

FIG. 31 shows an example of the forbidden zones 100a, 100b, and 100c generated when the left and right toothbrush bristles 23a and 23b and the middle toothbrush bristles 12a and 12b are configured in groups of two or more rows.

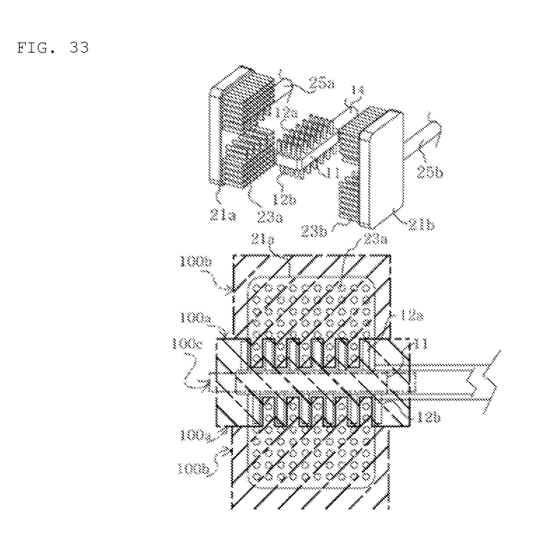

FIGS. 32 and 33 show examples of the forbidden zones 100a, 100b, and 100c generated when the left and right toothbrush bristles 23a and 23b and the middle toothbrush bristles 12a and 12b are configured in groups of one row.

### DIGIT ILLUSTRATION

1, 10a, 10b, 10c: middle toothbrush handle (original body)

11: middle toothbrush

12, 12a, 12b: middle toothbrush bristles

13a, 13b: left, right hinges

14: middle toothbrush neck

15, 15a, 15b: vibration plate

16, 16a, 16b: shaft coupling hole

17a, 17b: vibration coupling groove

18: slider guide

2a, 2b: left and right toothbrush handles

20a, 20b: coupled to shafts

21a, 21b: left and right toothbrushes

22a, 22b: the gears

23a, 23b: the left/right brush bristles

24a, 24b: left and right toothbrush hinge shafts

25a, 25b: left and right toothbrush necks

26a, 26b: hinge linking port

27a, 27b: gear jaws

28a, 28b: slider piston

29a, 29b: (slider) piston pressing iron

3, 3a, 3b, 3c, 3d, 3e: spring

31: elastic rubber ball

32a, 32b: ‘handle-integrated springs’ to form an elastic spring structure by extending sides of the left and right toothbrushes 21a and 21b

4a, 4aa, 4b, 4bb: elastic spring 41a, 41aa, 41b, 41bb: left and right toothbrush connectors

42a, 42b: the hinge

42c, 42cc: hinge coupling port

42d, 42dd: hinge coupling bolt

45: bearing ball

5, 5a, 5b: left, right toothbrush fastening ring

53a, 53b: left, right toothbrush hinge

70a: upper side surfaces of teeth

70b: lower side surfaces of teeth

70i: flat surface of the upper teeth

70ii: upper teeth internal side

70iii: upper teeth external side

70iv: lower teeth upper side

70v: lower teeth internal side

70vi: lower teeth external side

80: switch

80a: switch button

81: switch frame

82a, 82b: elastic insulation ring (rubber ring)

83: positive (+) electrode plate

84: negative (−) electrode plate

84a: battery module fastening jaw

9: battery module

91: battery module water-proof rubber

92a, 92b: battery charger

100a: left and right toothbrush bristle forbidden zones for protecting the middle toothbrush bristles

100b: middle toothbrush bristle forbidden zones for protecting the left and right toothbrush bristles

100c: left and right toothbrush bristle forbidden zones 100c for protecting the middle toothbrush

101a, 101b: left/right brush hinge shaft fastening rail groove

110a, 110b: side toothbrush rod clearance groove

120a, 120b: side toothbrush bristle clearance groove

181: the shaft 181 of the typical vibration device

180: vibration device

What is claimed is:

1. A toothbrush produced by providing soft bristles on a solid bar and capable of simultaneously cleaning six surfaces, e.g., upper and lower flat surfaces, upper left and right side surfaces, and lower left and right side surfaces, of teeth, the toothbrush comprising:
a middle toothbrush having top bristles and bottom bristles provided on top and bottom surfaces of the middle toothbrush to simultaneously clean the upper and lower flat surfaces of the teeth;
a left toothbrush meeting the middle toothbrush bristles and a middle toothbrush centerline at right angles to clean upper and lower side surfaces of the teeth in one of two side directions of the teeth;
a right toothbrush meeting the middle toothbrush bristles and the middle toothbrush centerline at right angles to clean upper and lower side surfaces of the teeth in the other of the two side directions of the teeth; and
a coupling means for coupling the middle toothbrush and the left and right toothbrushes together.

2. The toothbrush according to claim 1, wherein the coupling means comprises hinges.

3. The toothbrush according to claim 1, wherein the coupling means comprises connectors (links) and hinges.

4. The toothbrush according to claim 1, wherein the left and right toothbrushes comprise elastic springs (springs or rubber) for elastically opening or closing the left and right toothbrushes away from or toward the middle toothbrush.

5. The toothbrush according to claim 1, wherein the left and right toothbrushes comprise gears for opening or closing the left and right toothbrushes away from or toward the middle toothbrush by equal angles, and preventing the left and right toothbrushes from being open beyond a certain angle.

6. The toothbrush according to claim 1, wherein the middle toothbrush comprise clearance grooves in parts where the left and right toothbrushes and bristles thereof approach, to reduce interference between the middle toothbrush and the left and right toothbrushes during operation.

7. The toothbrush according to claim 1, wherein at least one of the middle toothbrush and the left and right toothbrushes comprises a typical vibration device 180 (a device using a typical vibration motor and at least one of a motor, a battery, an electronic circuit, a charger, etc.).

8. The toothbrush according to claim 1, wherein the middle toothbrush and the left and right toothbrushes are detachable from a middle toothbrush handle by providing a shaft coupling hole under the middle toothbrush and detaching a middle toothbrush handle shaft from the shaft coupling hole, and
wherein the left and right toothbrushes are detachable from the middle toothbrush handle by providing hinge shafts under of the left and right toothbrushes and providing arch-shaped coupling rail grooves at sides of the middle toothbrush handle.

9. The toothbrush according to claim 1, wherein the middle toothbrush and the left and right toothbrushes are detachable from a middle toothbrush handle by providing a shaft coupling hole under the middle toothbrush and detaching a middle toothbrush handle shaft from the shaft coupling hole, and
wherein the toothbrush further comprises a coupling ring for coupling lower parts of the left and right toothbrushes together using hinges, to store a detached coupled toothbrush structure in an upright orientation.

10. The toothbrush according to claim 7, further comprising a vibration plate at a side of a middle toothbrush neck to transfer vibration of the vibration device to the left and right toothbrushes or the middle toothbrush,
wherein vibration coupling grooves are generated at sides of the vibration plate and sides of left and right toothbrush necks are inserted into the vibration coupling grooves during operation to transfer vibration there between.

11. The toothbrush according to claim 1, wherein the coupling means integrally couples the middle toothbrush and the left and right toothbrushes together using slider pistons and a piston guide.

12. The toothbrush according to claim 11, further comprising springs in the slider pistons and the piston guide to provide recovery force to the slider pistons.

13. The toothbrush according to claim 11, wherein handles of all of the middle toothbrush and the left and right toothbrushes are detachable by providing a coupling hole under the piston guide and detaching a vibration shaft of the middle toothbrush handle from the coupling hole.

14. The toothbrush according to claim 11, wherein handles of all of the middle toothbrush and the left and right toothbrushes are detachable by providing coupling shafts (or coupling holes) under the left and right toothbrushes and detaching vibration device coupling holes (or shafts) of the left and right toothbrush handles from the coupling shafts (or the coupling holes).

15. The toothbrush according to claim 1, further comprising connectors (links) connected to the left and right toothbrushes, a slider coupled to the connectors using hinges and sliding along an outer circumferential surface of the middle toothbrush handle, and a slider recovery spring, to open or close the left and right toothbrushes away from or toward the middle toothbrush by equal angles.

16. The toothbrush according to claim 1, further comprising a switch button protruding to contact a side of the slider and pressed due to rectilinear motion of the slider, a switch, and a vibration device (a vibration motor, a battery module, + and − electrode plates, etc.) operating when the switch is turned on, in the middle toothbrush handle under the middle toothbrush.

17. The toothbrush according to claim 1, wherein the bristles are not provided on the middle toothbrush in bristle forbidden zones ‘for protecting left and right toothbrush’ bristles to prevent interference with the left and right toothbrushes meeting the middle toothbrush at right angles, during operation, and
wherein the bristles are not provided on the left and right toothbrush bristles in bristle forbidden zones ‘for protecting middle toothbrush bristles’ and bristle forbidden zones for ‘protecting a middle toothbrush neck’ to prevent interference with the middle toothbrush meeting the left and right toothbrushes at right angles, during operation.
